(19) United States
(12) Patent Application Publication
(10) Pub. No.: US 2022/0126462 A1
(43) Pub. Date: Apr. 28, 2022

(54) Decoupled Lock

(71) Applicant: Beren McKay, Lynnwood, WA (US)

(72) Inventor: Beren McKay, Lynnwood, WA (US)

(21) Appl. No.: 17/508,962

(22) Filed: Oct. 22, 2021

Related U.S. Application Data
(60) Provisional application No. 63/104,057, filed on Oct. 22, 2020.

(51) Int. Cl. B26B 1/04

(52) U.S. Cl. CPC B26B 1/044; B26B 1/046

(57) ABSTRACT

A decoupled lock is disclosed. One embodiment provides a knife having a handle pivotably attached to a knife blade, the knife blade having a closed position within the handle and an open position extended from the handle, and a decoupled lock having a blade engagement portion to lock the blade and a user interface portion to disengage the blade engagement portion, wherein the blade engagement portion is biased toward a locked position and the user interface portion disengages the blade engagement portion when the blade is in the open position and is decoupled from the blade engagement portion with the blade in the closed position. Other embodiments are described herein.

### BACKGROUND

### Field of the Invention

The invention relates to decoupled knife lock. More specifically the invention relates to an unlocking apparatus that is decoupled from a lock while a knife is in certain orientations.

### Prior Art

Knives have utilized locking cross-members to lock a knife in a certain orientation. One example of a locking cross-member is a lock post which interfaces with a notch in a blade tang. When the lock post is within the notch, the blade cannot rotate to a different position unless the lock post is actuated by a user through a button or other interface. However, if a lock post is used in an assisted opening knife, then the knife would operate as an automatic knife and would spring to an open position upon the user unlocking the lock post from the notch in the tang.

### SUMMARY

Accordingly, a decoupled lock is described below in the Detailed Description. For example, one disclosed embodiment provides a knife having a handle pivotably attached to a knife blade, the knife blade having a closed position within the handle and an open position extended from the handle, and a decoupled lock having a blade engagement portion to lock the blade and a user interface portion to disengage the blade engagement portion, wherein the blade engagement portion is biased toward a locked position and the user interface portion disengages the blade engagement portion when the blade is in the open position and is decoupled from the blade engagement portion with the blade in the closed position. Other embodiments are disclosed herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a left side view of some components of an embodiment decoupled lock.

FIG. 2 is a right side view of some components of an embodiment decoupled lock.

FIG. 3 is a left side section view of the embodiment shown in FIG. 1.

FIG. 4 is a left side perspective view of the embodiment shown in FIG. 1.

FIG. 5 is a perspective view of the embodiment in FIG. 1 showing the blade in an open orientation.

FIG. 6 is a perspective view of the embodiment in FIG. 1 showing the blade in an open orientation.

FIG. 7 is a left side view of the embodiment in FIG. 1.

FIG. 8 is a right side view of a safety mechanism and other components of the embodiment knife shown in FIG. 1.

FIG. 9 is a left side view of the embodiment in FIG. 1.

FIG. 10 is a left side view of the embodiment in FIG. 1.

FIG. 11 is a section view of some components of a second embodiment of a decoupled lock.

FIG. 12 is a section view of some components of a second embodiment of a decoupled lock.

FIG. 13 is a section view of some components of a second embodiment of a decoupled lock.

FIG. 14 is an exploded view of the embodiment shown in FIG. 1.

FIG. 15 shows a perspective view of an embodiment knife having a decoupled lock.

FIG. 16 shows the handle, slot, button, locking post and elongate channel arrangement as described with reference to embodiments herein.

### DETAILED DESCRIPTION

A decoupled knife lock and knife is disclosed. In some embodiments a decoupled lock knife 100 includes a handle having a first side handle 117 and second side handle 118 pivotably attached to a knife blade 120, the knife blade 120 having a closed position within the handle and an open position extended from the handle, and a decoupled lock having a lock post 125 to lock the blade and a user interface portion 140 to disengage the lock post 125, wherein in these embodiments the lock post 125 is biased toward a locked position and the user interface portion disengages the lock post 125 when the blade is in the open position and is decoupled from the lock post with the blade in the closed position.

Decoupled lock knife 100 further includes cap springs 142 and frame springs 144 interfacing between the user interface portion 140 and the lock post 125 for the cap springs and between the lock post 125 and the frame for the frame springs 144. User interface portion 140 has an elongate channel 141 to receive the lock post 125 wherein the lock post can move within the elongate channel 141.

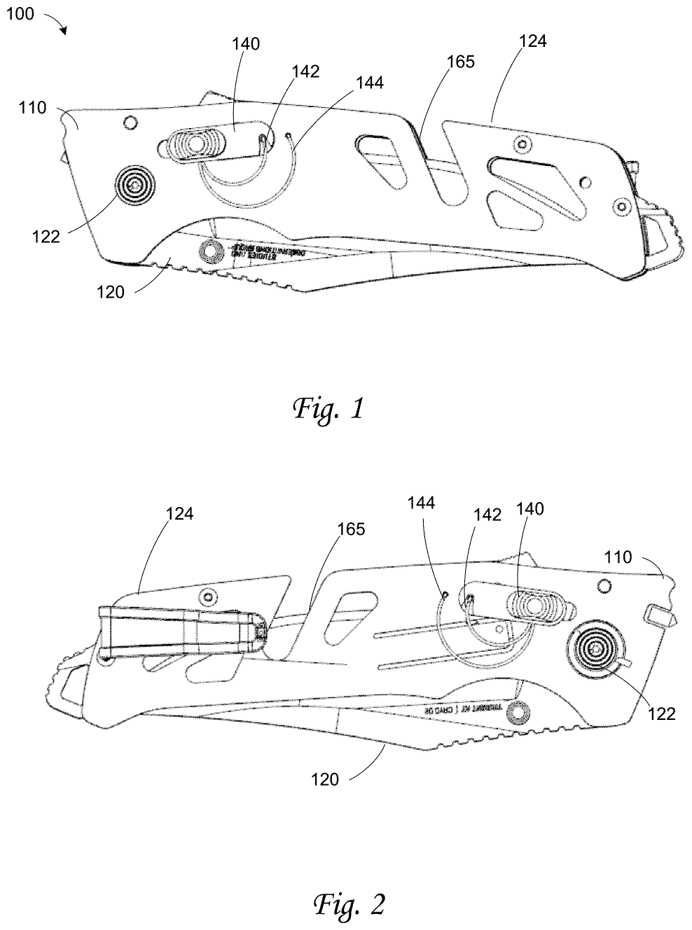

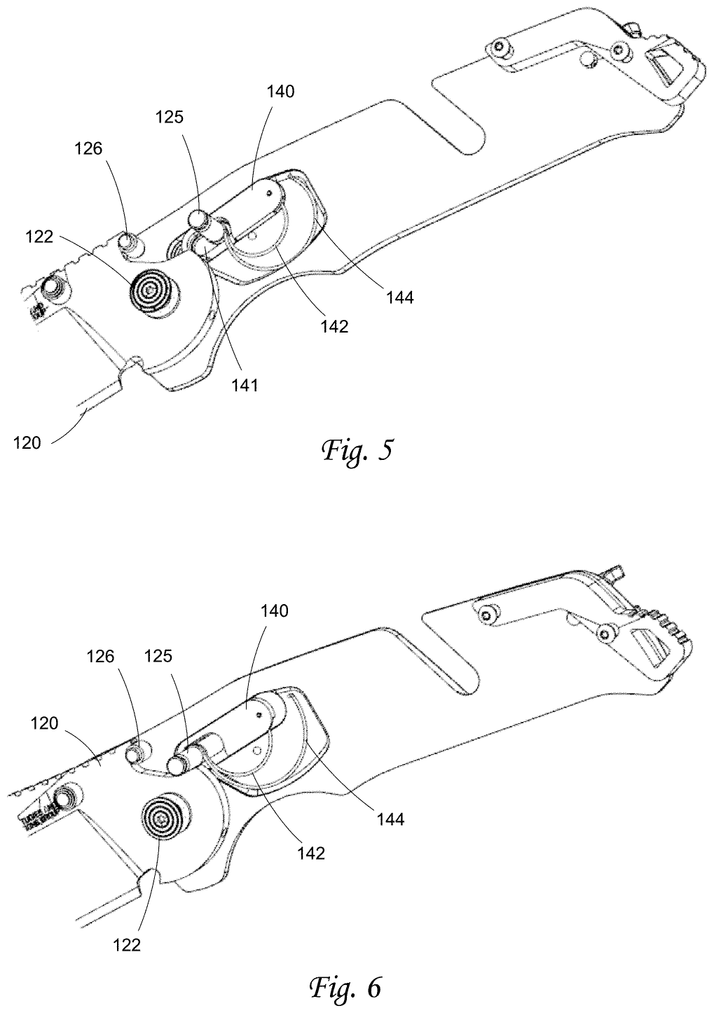

With reference to FIGS. 1-2, knife 100 includes a handle 112 having a channel 124 to receive a blade 120 that is pivotably attached to the handle 112. The knife includes liner 110 and liner 111 inside the handle, the liners 110 and 11 defining the sides of the channel 124. Knife 100 has a back spacer 153 positioned between first liner portion 110 and second liner portion 111. Some embodiments may use features within a handle 112 for knife lock and safety mechanisms without using liners. In the present embodiment, the blade 120 has a blade tang 121 (see FIGS. 5-6) with a front and a rear geometry to interface with a lock post 125. The lock post 125 is actuated by a lock button 140 that is decoupled from the lock post 125 when the lock post is in a first position, but is coupled with the lock post in a second position. In some embodiments, the lock button 140 can move lock post 125 while the blade is in a closed orientation without moving the lock post 125 enough to unlock the blade.

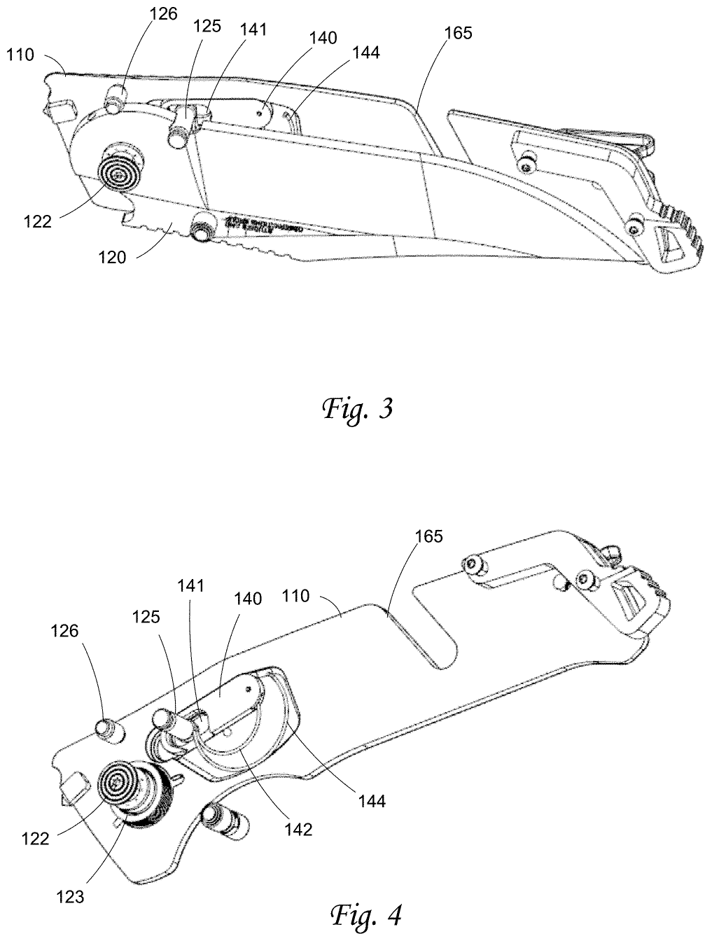

In the present decoupled embodiment as shown in FIG. 3, a lock button 140 includes an elongate channel 141 to receive the lock post 125, where the lock post 125 can move along the elongate channel 141. In knife 100, a first end of the elongate channel is adjacent to the lock post while the blade is in the open position. In this way, the first end of the elongate channel 141 can move the lock post from a locked position against the blade tang 121 by moving the lock button 140 toward an unlocked position. With the blade 120 in the closed position the button imparts no opening force on the lock post 125 and therefore is decoupled from unlocking in this blade closed position.

In this embodiment, in the closed position the front geometry of the blade tang 121 does not interface with the lock post 125 in an over-center manner enough to create a hard lock and therefore allows opening rotation of the blade 120 which displaces the lock post 125 while the lock button 140 is either stationary or is otherwise decoupled from the lock post 125. In the illustrated embodiment, the lock button 140 is restricted from moving further in the unlocking direction while the lock post 125 can move further in the unlocking direction, allowing the blade 120 to open by force acting on the blade but to not open by actuation of the lock button 140. While in the blade open orientation, a rotation of the blade 120 will not displace the lock post 125, while in the blade closed orientation a blade rotation will displace the lock post 125.

In the current embodiment, a lock post spring 144 biases the lock post 125 to a locked position and a user overcomes the lock post spring 144 by moving the lock button 140 to an unlocked position where the first end of the elongate channel 141 moves the lock post 125 out of engagement with the blade tang 121, allowing the blade 120 to rotate about the pivot 122 in the handle 112. Other embodiments are not limited in this way and may decouple the lock button 140 from the lock post 125 without use of a lock post spring 144. Additionally, a lock button spring 142 may bias the lock button 140 to a position which can be overcome by a user actuating the lock button 140.

In embodiment knife 100, the lock post spring 144 is connected to at least one liner 110 and the lock post spring 144 is coupled to the lock post 125. However, other embodiments may anchor the lock post spring 144 to the handle, to a lockbar, to a knife frame, etc., and may anchor the lock button spring 142 to the liner, the handle, a lockbar, a knife frame, etc. In this way, the lock post 125 and lock button 140 can be biased to respective positions while being decoupled from each other in a blade closed position. In some embodiments, the lock post 125 and lock button 140 may also be decoupled when the blade is not in a closed orientation.

In some embodiments, a folding knife 100 with a decoupled lock includes a handle 112 pivotably attached to a knife blade 120, where the knife blade 120 has a closed position substantially within the handle 112 and an open position extended from the handle 112, and a decoupled lock having a locking member 125 to lock the blade 120 wherein the locking member 125 is biased to a locked position, and the knife further having a lock button 140 to disengage the locking member 125 from the blade 120. The locking member 125 further has a first position to lock the blade 120 in place, a second position to unlock the blade 120, and a third position that is decoupled from the button 140, wherein when the locking member 125 is in the first position the button 140 can move the locking member to the second position to unlock the blade and when the locking member is in the third position the button is decoupled from the locking member. In some embodiments the locking member may have a fourth position where it can travel further in the unlocking direction while the button 140 is still decoupled from the locking member 125.

In an alternate embodiment, a knife may have a first resting position for a locking member 125 where the locking member 125 rests with the blade 120 in an open and a closed position, with the lock button 140 decoupled from the locking member 125 while the blade 120 is in a closed position. That is, the locking member 125 can be disengaged from the blade 120 based upon blade position independent from lock button 140 position.

In some embodiments, a folding knife 100 includes a handle 112 having a first sidewall and a second sidewall, the handle having a first spring attachment point, and the handle having a pivot pin 122 and pivot spring 123 mounted between the first sidewall and the second sidewall for pivotably attaching the knife blade 120, the handle 112 further having a slot 147 on the inside of the first sidewall to house a knife lock slider 140, and a first inner liner 110 adjacent the first sidewall and a second inner liner adjacent the second sidewall, the first and second inner liners defining a storage area for a knife blade 120, wherein the first liner 110 is a sidewall for the slot 147. The present embodiment includes a blade having a blade tang 121 with a front tang geometry and a back tang geometry, the blade having a pivot hole wherein the blade is pivotably attached to the handle 112 with the pivot pin 122 protruding through the pivot hole.

The present embodiment further includes a knife lock having a knife lock slider 140 to fit within the slot 147 and adjacent to the first liner, a crossbar lock 125 fit movably within an elongate channel within the lock slider 140, the crossbar lock 125 to push against the blade tang 121, the crossbar lock 125 being coupled to a first spring 144 that is connected to the knife handle at the first spring attachment point and the crossbar lock 125 being coupled to a second spring 142 that is connected to a second spring attachment on the lock slider 140 such that the first spring biases the lock to a locked position. In this way, when the knife 100 is in an open position with the blade extended from the handle, the lock slider 140 can slide between a first position in the slot that locks the blade 120 and a second position in the slot that unlocks the blade 120 to allow closing, and when the blade is in the closed position the lock slider 140 does not disengage the crossbar lock 125 from the tang.

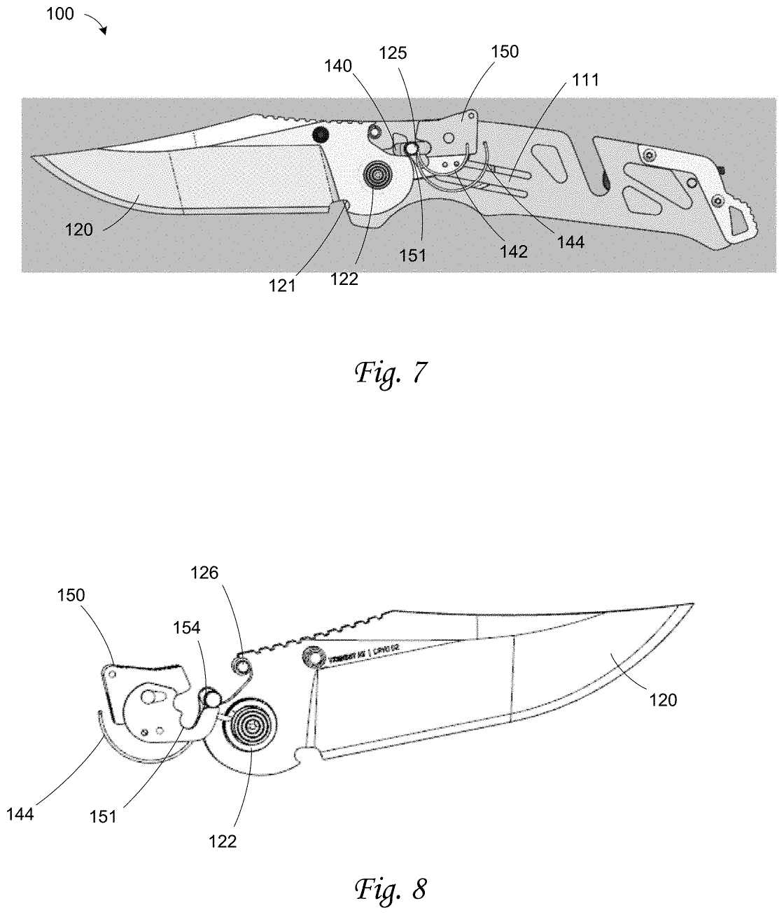

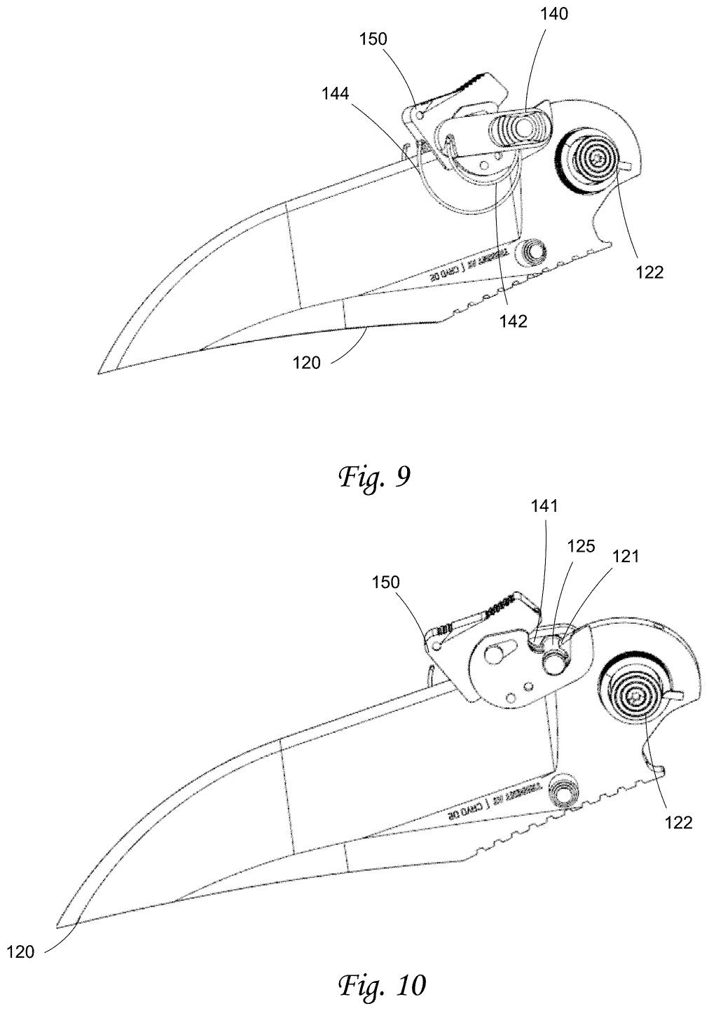

As shown in FIGS. 7-10, in some embodiments a knife has a safety 150 pivotably mounted between the two liners 110 or between handle 112 portions and having a lock post recess 151 to receive the lock post when the lock slider 140 is decoupled from the lock post 125, and a second recess 152 to allow movement of the lock post 125 within the recess, and an interface 154 to rest adjacent to the lock post 125 and obstruct pivoting movement of the safety. In this embodiment, the lock post 125 can move independently of the lock slider 140 with the knife in the closed position unless the safety is pivoted to align the lock post recess 151 with the lock post. In this way, the safety can hold the lock post within the lock post recess 151 or against a surface of the blade tang and restrict opening of the blade 120.

In some embodiments, the safety has a toggle button 155 having a first post to fit within a hole in a first liner, and a second post to fit within a hole in a second liner, and to pivot between at least two positions. In this way, the toggle button 155 is coupled to a safety plate 156 having a first recess to receive a lock post 125, a second recess to allow movement of the lock post within the recess to open the knife, and an interface 154 to rest adjacent to the lock post and obstruct the toggle button from pivoting.

In the present example embodiment, the safety has a lock post interface 154 with a notch to receive the lock post while the safety is on, and obstruct the lock post from an unlocking movement. The lock post may be additionally obstructed by a concave front tang geometry, where the lock post 125 is secured between the concave front tang geometry and the notch in the lock post interface 154. In this way, the lock post interface has a first surface alongside the notch, and while the blade is in the open position, the first surface rests on the lock post and prevents the safety from rotating out of a safety off orientation.

The safety plate or toggle button 155 may further have one or more detents to receive a bearing placed within a cantilever spring 111 in the liner, wherein the cantilevered spring 111 presses the bearing towards the detent to hold the safety in a safety on or safety off orientation. In this way, while the safety is off, the lock post 125 is decoupled from the lock slider 140 or lock button, and the blade 120 can rotate open, where as the blade is rotated open the lock post 125 is pushed to an unlocked position by the contour of the blade tang. Conversely, when the safety is placed in a safety on position, the lock post 125 is held against the blade tang by the safety plate to prevent the blade 120 from opening.

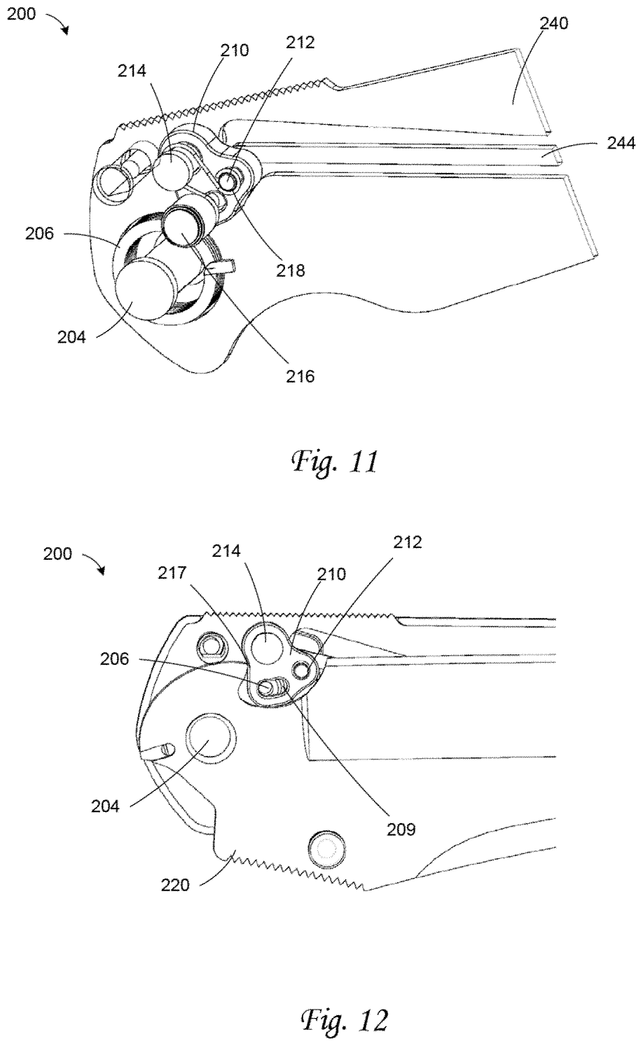

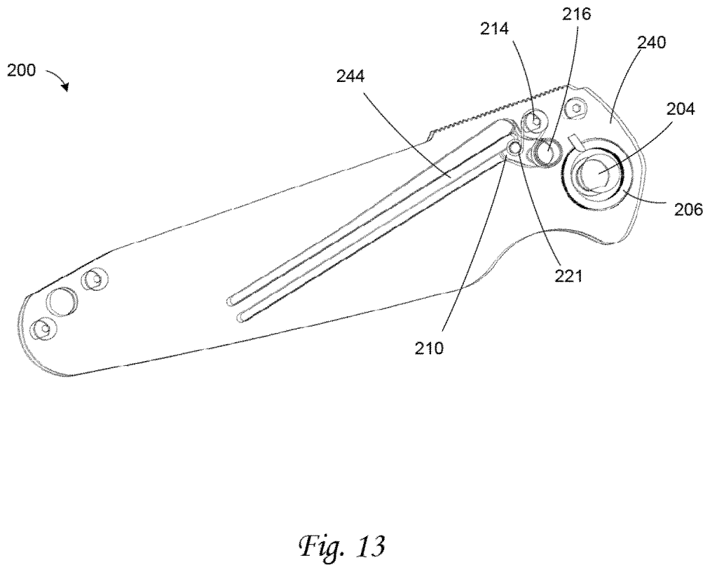

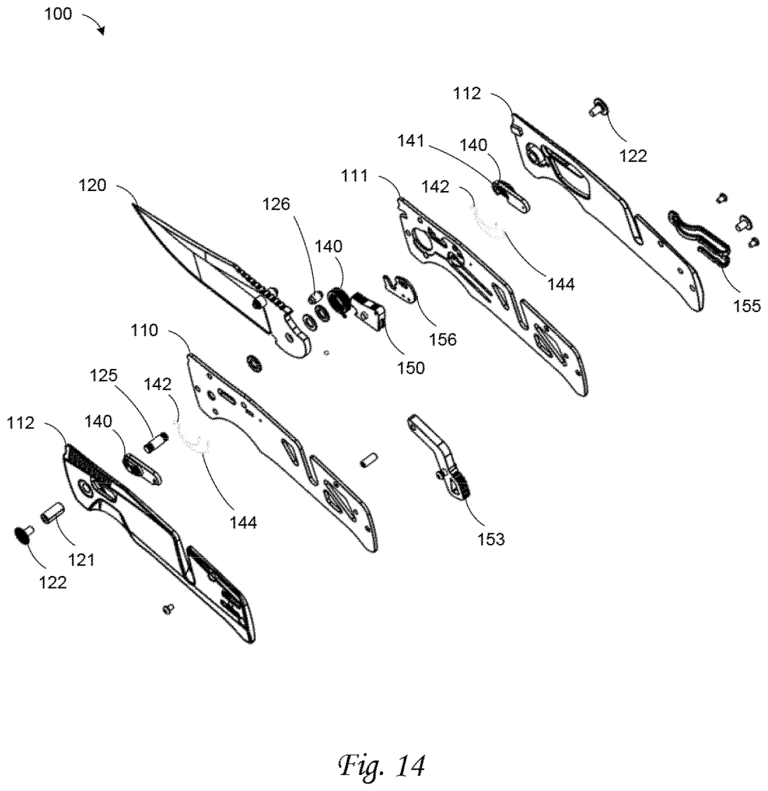

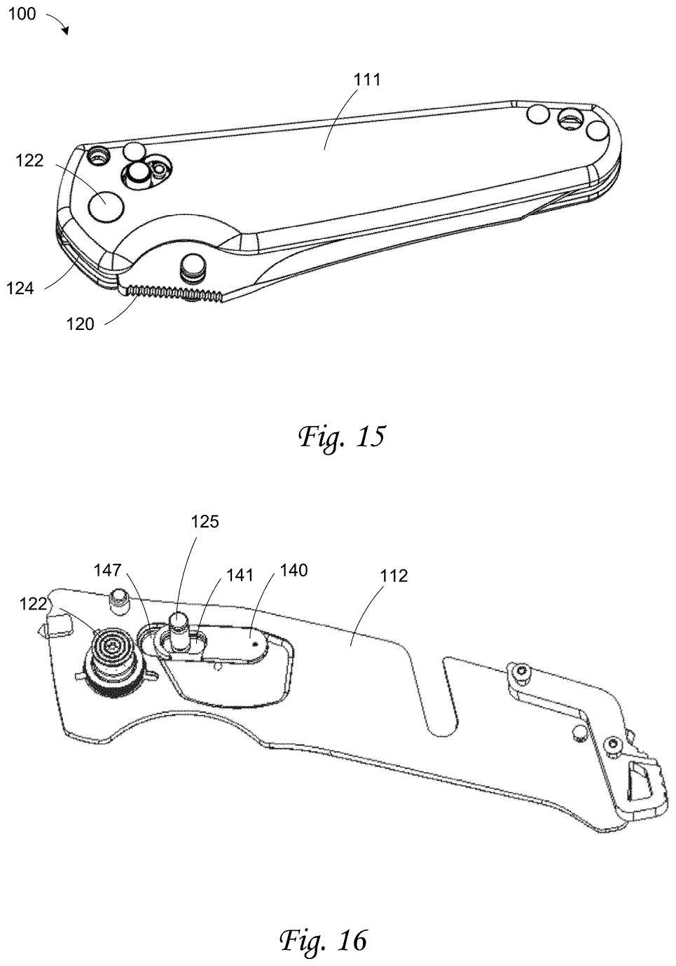

FIGS. 11-13 show a second embodiment knife 200 having a camming decoupled lock. In this embodiment, when the blade 220 is in a closed orientation, a spring 244 biases the cam 210 to a forward and locked position. In this position, a locking button 216 is allowed to move within a slot in the cam 210, while the locking button 216 does not move far enough to disengage the cam 210 from the blade tang 220 at 217. In the present embodiment, the blade tang 220 geometry interfaces with the cam 210 where the blade 220 can be rotated open and the blade tang displaces the cam 210 from the locked position 217. Therefore, the locking button 216 does not unlock the cam 210 yet the blade 220 can be rotated open by use of a thumb stud, an interface on the blade, or other interfaces on the blade or attached to it. As the blade 220 is opening, the cam 210 is still biased toward a locked position by the spring 244 biasing it and when the blade is opened far enough, a back tang geometry receives the cam 210 and locks the blade 220 in the open position. In this open orientation the locking button 216 then is used to move the cam 220 from a locked position.

In another embodiment, knife 200 includes a blade having a front tang portion and a back tang portion, wherein the front tang portion is adjacent to a cutting edge on the blade, the blade having a pivot hole for receiving a pivot pin to attach the blade to a handle, and a handle defining a channel to house the blade and a pivot pin between a first handle portion and a second handle portion, wherein the pivot pin extends through the pivot hole to pivotably attach the blade to the handle. Knife 200 further includes a lock having a lock button and a cam 210 wherein the cam is connected to the handle with a lock pivot pin, the lock including a lock spring to bias the cam 210 toward a locked orientation, wherein when the blade is in a closed position the lock button does not disengage the cam 210 from the blade at the front tang portion, and when the blade is in an open position the lock button disengages the cam 210 from the back tang portion.

In some embodiments, knife 200 includes a liner within the handle and defining the channel to receive the blade. The handle further comprises a liner spring to bias the cam 210 toward a locked position. Other embodiments are not so limited and example lock springs include a cantilevered spring, a coil spring, omega springs, etc., or other springs biasing the rocker toward a locked position.

In some embodiments, a locking member may be decoupled from a locking button for a portion of the range of movement of the locking button movement and coupled for a different portion of the range of movement of the locking button. In one example, a lock post may travel within an elongate channel in a locking button, and when it is coupled to the locking button, then movement of the locking button will move the locking member or lock post, but while it is decoupled, movement of the locking button will not move the locking member or lock post. Further in this embodiment, in the knife closed state the range of coupling is insufficient to move the lock bar out of a locked position, but in the knife open state the range of coupling is enough to move the lock bar out of a locked position.

With reference to FIG. 11 and FIG. 12, a liner 240 includes a liner spring 244 that interfaces with a post 212 coupled with the cam 210 to rotate around a cam pivot 214 and bias the cam 210 to rotate into a position to contact the blade tang 217 and obstruct the blade from moving from an open or a closed position. Cam 210 includes an opening defining a decoupling slot 209 that receives a post connected with lock button 216. The decoupling slot 209 allows partial rotation of cam 210 without requiring lock button 216 to be moved. In this way, cam 210 can rotate into a locking position against the blade 220 with the blade 220 in a closed orientation and the cam is decoupled from the locking button 216 due to the decoupling slot and locking button post arrangement.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof

1. A folding knife, comprising:
a handle pivotably attached to a knife blade, the knife blade having a closed position within the handle and an open position extended from the handle; and
a decoupled lock having a blade engagement portion to lock the blade and a user interface portion to disengage the blade engagement portion, wherein the blade engagement portion is biased toward a locked position and the user interface portion disengages the blade engagement portion when the blade is in the open position and is decoupled from the blade engagement portion with the blade in the closed position.

2. The folding knife of claim 1, further comprising an interface spring to bias the user interface portion toward the blade engagement portion in the locked position.

3. A folding knife, comprising:
a blade having a front tang portion and a back tang portion, wherein the front tang portion is adjacent to a cutting edge on the blade, the blade having a pivot hole for receiving a pivot pin to attach the blade to a handle;
a handle defining a channel to house the blade and a pivot pin between a first handle portion and a second handle portion, wherein the pivot pin extends through the pivot hole to pivotably attach the blade to the handle;
a lock having a lock post and at least one lock handle, the lock post having a lock spring biasing the lock post toward a locked orientation, wherein when the blade is in a closed position the lock handle is decoupled from the lock post, and when the blade is in an open position the lock handle can disengage the lock post from the back tang portion.

4. The folding knife of claim 3, further comprising a spring to bias the lock handle to a first position.

5. The folding knife of claim 3, further comprising the lock handle having an open channel to receive the lock post, wherein the open channel allows the lock handle to move along the open channel a first distance before engaging the lock post.

6. The folding knife of claim 5, wherein the front tang portion extends further toward the lock post than the back tang portion, and wherein when the knife is in the closed position the lock handle moves the first distance along the open channel and does not disengage the lock post from the front tang portion.

7. The folding knife of claim 6, wherein when the blade is in the open position, while the lock handle moves the first distance along the open channel, the back tang portion being further away from the lock post than the front tang portion allows the lock handle to disengage the lock post from the back tang portion.

8. A folding knife, comprising:
a handle having a first sidewall and a second sidewall, the handle having a first spring attachment point, and the handle having a pivot pin mounted between the first sidewall and the second sidewall for pivotably attaching the knife blade, the handle further having a slot on the inside of the first sidewall to house a knife lock slider;
a first inner liner adjacent the first sidewall and a second inner liner adjacent the second sidewall, the first and second inner liners defining a storage area for a knife blade, wherein the first liner is a sidewall for the slot;
a blade having a blade tang with a front tang geometry and a back tang geometry, the blade having a pivot hole wherein the blade is pivotably attached to the handle with the pivot pin protruding through the pivot hole;
and a knife lock having a knife lock slider to fit within the slot and adjacent to the first liner, a crossbar lock fit movably within the lock slider, the crossbar lock to push against the blade tang, the crossbar lock being coupled to a first spring that is connected to the knife handle at the first spring attachment point and the crossbar lock being coupled to a second spring that is connected to a second spring attachment on the lock slider such that the first spring and the second spring both bias the lock to a locked position, wherein when the knife is in the open position with the blade extended from the handle the lock slider can slide between a first position in the slot that locks the blade and a second position in the slot that unlocks the blade to allow closing, and when the blade is in the closed position the knife slider does not disengage the crossbar lock from the tang.

9. A folding knife, comprising:
a blade having a front tang portion and a back tang portion, wherein the front tang portion is adjacent to a cutting edge on the blade, the blade having a pivot hole for receiving a pivot pin to attach the blade to a handle;
a handle defining a channel to house the blade and a pivot pin between a first handle portion and a second handle portion, wherein the pivot pin extends through the pivot hole to pivotably attach the blade to the handle;
a lock having a lock button and a cam wherein the cam is connected to the handle with a lock pivot pin, the lock including a lock spring to bias the cam toward a locked orientation, wherein when the blade is in a closed position the lock button does not disengage the cam from the blade at the front tang portion, and when the blade is in an open position the lock button disengages the cam from the back tang portion.

10. The folding knife of claim 9, further comprising a lock button spring to bias the lock button to a first position.

11. The folding knife of claim 9, further comprising the lock having an open channel to receive the lock post, wherein the open channel allows the lock button to a first distance before engaging the lock post.

12. The folding knife of claim 11, wherein the front tang portion extends further toward the lock post than the back tang portion, and wherein when the knife is in the closed position the lock button moves the first distance along the open channel and does not disengage the lock post from the front tang portion.

13. The folding knife of claim 12, wherein when the blade is in the open position, while the lock button moves the first distance along the open channel, the back tang portion being further away from the lock post than the front tang portion allows the lock button to disengage the lock post from the back tang portion.

14. A folding knife having a decoupled lock, comprising:
a handle pivotably attached to a knife blade, the knife blade having a closed position substantially within the handle and an open position extended from the handle; and
a decoupled lock having a locking member to lock the blade wherein the locking member is biased to a locked position, and the knife further having a button to disengage the locking member from the blade, the locking member having a first position to lock the blade in place, the locking member having a second position to unlock the blade, and the locking member having a third position that is decoupled from the button, wherein when the locking member is in the first position the button can move the locking member to the second position to unlock the blade and when the locking member is in the third position the button is decoupled from the locking member.

15. The folding knife with decoupled lock of claim 14, wherein when the lock post rests in the same position when the blade is open and closed.
